(19) United States
(12) Patent Application Publication
(10) Pub. No.: US 2021/0291697 A1
(43) Pub. Date: Sep. 23, 2021

(54) POWER TRADING SYSTEM FOR ELECTRICALLY DRIVEN VEHICLE AND CHARGING AND DISCHARGING APPARATUS

(71) Applicant: Toyota Jidosha Kabushiki Kaisha, Toyota-shi Aichi-ken (JP)

(72) Inventors: Masahiro Nishiyama, Toyota-shi (JP); Kenji Tsukagishi, Toyota-shi (JP); Takahisa Kaneko, Toyota-shi (JP); Erina Kigoshi, Tokyo (JP); Aiko Miyamoto, Toyota-shi (JP)

(73) Assignee: Toyota Jidosha Kabushiki Kaisha, Toyota-shi Aichi-ken (JP)

(21) Appl. No.: 17/188,223

(22) Filed: Mar. 1, 2021

(30) Foreign Application Priority Data
Mar. 17, 2020 (JP) 2020-046894

(51) Int. Cl. B60L 55/00; B60L 53/66; B60L 53/30

(52) U.S. Cl. CPC B60L 55/00; B60L 2250/16; B60L 53/305; B60L 53/665

(57) ABSTRACT

A display control unit of a charging and discharging apparatus causes a display unit to display a trading price display screen including a current trading price of power acquired by a communication unit from a power company (or a wholesale power trading center) via a communication line. A management content determination unit determines management content for trading power of a battery of an electrically driven vehicle in response to an instruction input from a user with reference to the trading price display screen. A charging and discharging processing unit executes charging and discharging processing of the battery according to the management content determined by the management content determination unit.

### CROSS-REFERENCE TO RELATED APPLICATION

This application claims priority to Japanese Patent Application No. 2020-046894 filed on Mar. 17, 2020, incorporated herein by reference in its entirety.

### BACKGROUND

### 1. Technical Field

The present specification discloses a power trading system for an electrically driven vehicle and a charging and discharging apparatus.

### 2. Description of Related Art

An electrically driven vehicle including a battery is well-known.

Examples of the electrically driven vehicle include an electric vehicle and a hybrid vehicle that use battery power as a drive source. An electrically driven vehicle in the present specification may be any vehicle as long as it includes a battery. Generally, a battery of an electrically driven vehicle is charged by connecting the electrically driven vehicle to a charging and discharging apparatus provided at a charging station or at a home.

There has been a system that handles power trading by charging and discharging between an electrically driven vehicle and a charging and discharging apparatus. For example, Japanese Unexamined Patent Application Publication No. 2011-55572 discloses a system in which, when power is supplied from a charging and discharging apparatus to an electrically driven vehicle, a user of the electrically driven vehicle deposits a power rate to the charging and discharging apparatus side, and when the power is supplied from the electrically driven vehicle to the charging and discharging apparatus, the charging and discharging apparatus side deposits the power rate to the user of the electrically driven vehicle.

### SUMMARY

However, in the same manner as, for example, a stock price, a trading price, which is a purchasing price or a selling price for power, may change over time based on a relationship between supply and demand of power, or the like. In this case, it is conceivable to manage (sell, purchase, hold, and the like) power of an electrically driven vehicle as if it were a stock. In management of trading the power of an electrically driven vehicle, a user of the electrically driven vehicle may determine management content for the power of the electrically driven vehicle after recognizing a current trading price of power.

A power trading system for an electrically driven vehicle disclosed in the present specification enables a user of the electrically driven vehicle to determine management content for trading power of the electrically driven vehicle according to a current trading price of power.

A power trading system for an electrically driven vehicle according to a first aspect of the present disclosure is configured to trade power for charging and discharging of a battery of the electrically driven vehicle. The power trading system includes a display device configured to display a current trading price of power and at least one processor configured to set management content for trading power of the battery in response to an instruction of a user and control the charging and discharging of the battery according to the set management content.

With the above configuration, since the current trading price of power is displayed on the display device, the user can easily recognize the current trading price of power. As such, the user can determine the management content for trading power of the electrically driven vehicle according to the current trading price of power.

In the above aspect, when the current trading price of power is a price lower than a predetermined threshold value, the processor may set, as the management content, management in which power selling for selling the power of the battery is not selected.

In the above aspect, the processor may control the charging and discharging of the battery in response to the instruction of the user while making a permissible charging amount of the battery greater than a normal permissible charging amount.

In the above aspect, the processor may set the management content based on the management content selected by the user from among a plurality of pieces of management content for trading the power of the battery.

In the above aspect, the plurality of pieces of management content for trading the power of the battery may include power selling, power purchasing, and power storage.

Further, a charging and discharging apparatus according to a second aspect of the present disclosure is configured to control charging and discharging of a battery in a power trading system for an electrically driven vehicle, which trades power for the charging and discharging of the battery of the electrically driven vehicle. The charging and discharging apparatus includes a display device configured to display a current trading price of power and at least one processor configured to set management content for trading the power of the battery in response to an instruction of a user and control the charging and discharging of the battery according to the set management content.

With each aspect of the present disclosure, a user of an electrically driven vehicle can determine management content for trading power of the electrically driven vehicle according to a current trading price of power.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic diagram of a configuration of a power trading system according to the present embodiment;

FIG. 2 is a schematic diagram of a configuration of an electrically driven vehicle according to the present embodiment;

FIG. 3 is a schematic diagram of a configuration of a charging and discharging apparatus according to the present embodiment;

FIG. 4 is a diagram illustrating an example of a trading price display screen;

FIG. 5 is a schematic diagram of a configuration of a server according to the present embodiment;

FIG. 6 is a graph illustrating changes in a power trading price over time;

FIG. 7 is a schematic diagram of the configuration of the electrically driven vehicle according to a modified embodiment;

FIG. 8 is a schematic diagram of a configuration of a user terminal according to the modified embodiment; and

FIG. 9 is a flowchart illustrating a flow of processing of the power trading system according to the present embodiment.

### DETAILED DESCRIPTION OF EMBODIMENTS

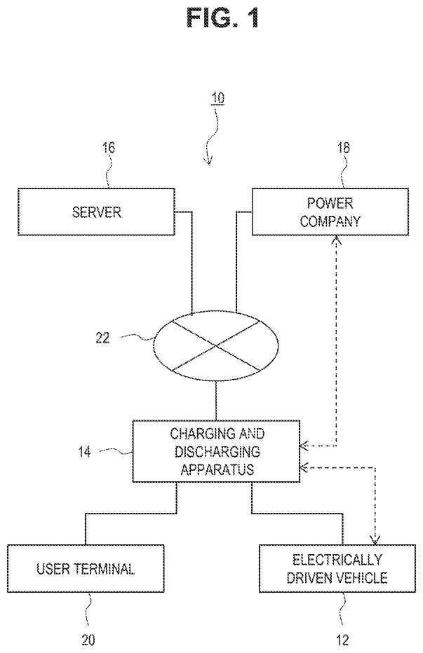

FIG. 1 is a schematic diagram of a configuration of a power trading system 10 for an electrically driven vehicle according to the present embodiment. The power trading system 10 includes an electrically driven vehicle 12, a charging and discharging apparatus 14, a server 16, a power company 18, and a user terminal 20. The charging and discharging apparatus 14, the server 16, and the power company 18 are communicably connected to one another via a communication line 22, such as a LAN or the Internet. Further, the electrically driven vehicle 12 and the user terminal 20 can be communicably connected to the charging and discharging apparatus 14 via wired or wireless near-field communication.

Further, a power transmission line is provided between the charging and discharging apparatus 14 and the power company 18, and power is transmitted/received between the charging and discharging apparatus 14 and the power company 18 via the power transmission line. Further, the electrically driven vehicle 12 and the charging and discharging apparatus 14 are connected to each other via a power cable or the like so as to be able to transmit/receive power. Alternatively, the electrically driven vehicle 12 and the charging and discharging apparatus 14 may be able to transmit/receive power therebetween without any contact. Dashed arrows in FIG. 1 represent power transmission/reception routes.

The electrically driven vehicle 12, the charging and discharging apparatus 14, and the server 16 will be described below in detail.

The power company 18 transmits power from a power grid to the charging and discharging apparatus 14. Further, the power company 18 can also receive power from the charging and discharging apparatus 14. The power company 18 determines a trading price including a price (purchasing price) for purchasing power from the power company 18 and a price (selling price) for selling power to the power company 18. The trading price can change over time according to, for example, a balance between supply and demand of power. Other apparatuses, such as the charging and discharging apparatus 14, can obtain a current trading price 82 of power by accessing the power company 18 via the communication line 22.

The user terminal 20 is a mobile terminal, such as a smartphone or a tablet terminal, and is carried by a user of the electrically driven vehicle 12 (hereinafter, simply referred to as a “user”). The user terminal 20 includes a communication unit composed of a network adapter or the like, a storage unit composed of a RAM, a ROM, or the like, a display unit composed of a liquid crystal display or the like, an input unit composed of a touch panel, a button, or the like, and a control unit composed of a CPU, a microcomputer, or the like.

In the power trading system 10, power of the electrically driven vehicle 12 can be traded between the user and the power company 18. Specifically, when the user purchases power from the power company 18 and the power is supplied from the charging and discharging apparatus 14 to the electrically driven vehicle 12, the user pays a power rate to the power company 18 according to a trading price. Further, when the user sells power to the power company 18 and the power is supplied from the electrically driven vehicle 12 to the charging and discharging apparatus 14, the power company 18 pays the power rate to the user according to a trading price.

The power trading system 10 may include a wholesale power trading center in which power is traded. In this case, the user may trade power with the wholesale power trading center.

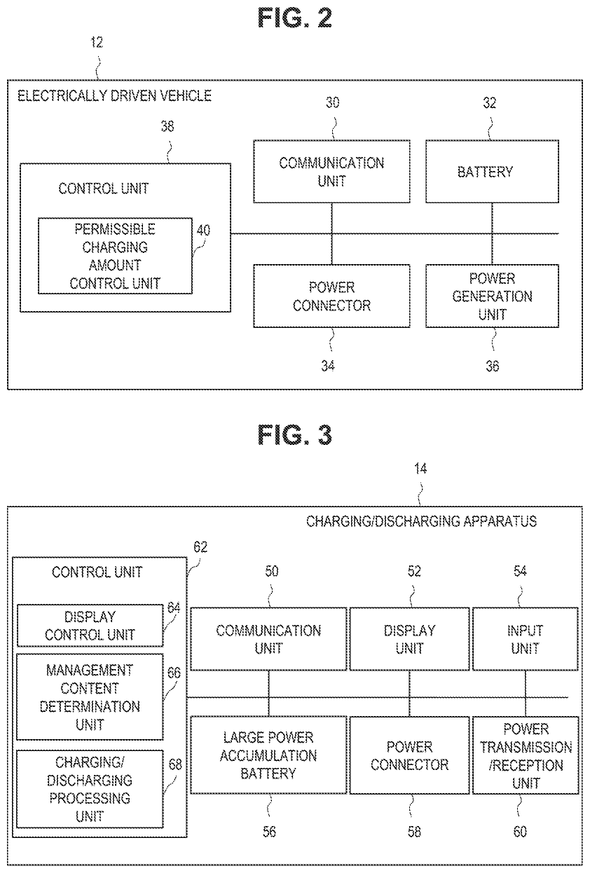

FIG. 2 is a schematic diagram of a configuration of the electrically driven vehicle 12. The electrically driven vehicle 12 includes a battery that accumulates power, and may be, for example, an electric vehicle or a hybrid vehicle using power as a drive source. As described above, the electrically driven vehicle 12 may be any vehicle as long as it includes a battery.

A communication unit 30 is composed of, for example, a near-field network adapter, such as a Bluetooth® adapter. The communication unit 30 exhibits a function of communicating with the charging and discharging apparatus 14 via wired or wireless near-field communication. Further, the communication unit 30 may be composed of a network adapter or the like, and may be able to communicate with the server 16 and the power company 18 via the communication line 22.

A battery 32 is a secondary battery, such as a lithium battery. Power is stored in the battery 32, and the electrically driven vehicle 12 can be driven by using the power of the battery 32 as a drive source. Further, in the power trading system 10, the user can manage the power of the battery 32 as an asset.

A power connector 34 is used for connecting the power cable. By connecting the electrically driven vehicle 12 to the charging and discharging apparatus 14 via the power cable, power can be transmitted/received between the electrically driven vehicle 12 and the charging and discharging apparatus 14. Specifically, the battery 32 is charged when the electrically driven vehicle 12 receives power supplied from the charging and discharging apparatus 14, and power is supplied from the electrically driven vehicle 12 to the charging and discharging apparatus 14 when the battery 32 is discharged.

A power generation unit 36 is composed of, for example, a solar panel. The power generation unit 36 has a power generation function, and the battery 32 is charged with the generated power. The power generation unit 36 may be able to generate power like solar power generation using a solar panel even while the electrically driven vehicle 12 is not operating, such as when the vehicle is parked in a parking lot. With such a power generation unit 36, even while the electrically driven vehicle 12 is not operating, the battery 32 can be charged with power traded as an asset.

A control unit 38 includes, for example, an ECU. The control unit 38 controls each unit of the electrically driven vehicle 12. Further, as illustrated in FIG. 2, the control unit 38 can also function as a permissible charging amount control unit 40.

The permissible charging amount control unit 40 controls a permissible charging amount of the battery 32. Generally, from the viewpoint of extending life of the battery 32, the permissible charging amount of the battery 32 is controlled such that it becomes a value smaller than a maximum chargeable amount. However, in the present embodiment, the power with which the battery 32 is charged is an asset to be traded. For this reason, the battery 32 may be charged with a greater amount of power. Therefore, according to an instruction of the user, the permissible charging amount control unit 40 increases the permissible charging amount of the battery 32 with respect to a normal permissible charging amount. For example, while the user is selecting a specific management mode (for example, a charging amount-oriented mode) as a management mode of the electrically driven vehicle 12, the permissible charging amount control unit 40 increases the permissible charging amount of the battery 32 as compared with the other management modes.

FIG. 3 is a schematic diagram of a configuration of the charging and discharging apparatus 14. The charging and discharging apparatus 14 is used for charging and discharging power with respect to the battery 32 of the electrically driven vehicle 12. The charging and discharging apparatus 14 is installed at a charging station (a charging stand) on a road, or at the user's home.

Prior to an operation by the user, the charging and discharging apparatus 14 authenticates the user. The user is authenticated by, for example, an input of a user ID and a password for uniquely identifying the user. Alternatively, the user is authenticated by a reading of an ID card on which the user ID is written. As such, the charging and discharging apparatus 14 can specify the user who is operating the charging and discharging apparatus 14.

A communication unit 50 is composed of, for example, a network adapter and a near-field network adapter. The communication unit 50 exhibits a function of communicating with other devices, such as the server 16, via the communication line 22. Further, the communication unit 50 exhibits a function of communicating with the electrically driven vehicle 12 and the user terminal 20 via wired or wireless near-field communication.

A display unit 52 is composed of, for example, a liquid crystal display. Various screens are displayed on the display unit 52.

An input unit 54 is composed of, for example, various buttons, or a touch panel. The input unit 54 is used for inputting the user's instruction to the charging and discharging apparatus 14.

A large power accumulation battery 56 is a secondary battery, such as a lithium battery. The large power accumulation battery 56 can accumulate a great amount of power, and can accumulate at least a much greater amount of power than the battery 32 of the electrically driven vehicle 12.

A power connector 58 is used for connecting the power cable that connects the electrically driven vehicle 12 to the charging and discharging apparatus 14.

A power transmission/reception unit 60 is a power transmission/reception port used for receiving power from the power company 18, that is, the power grid, and transmitting power to the power grid. The battery 32 of the electrically driven vehicle 12, which is connected via the power cable, is charged when the power transmission/reception unit 60 receives power from the power grid. Further, the power transmission/reception unit 60 can transmit, to the power grid, the power from the discharged battery 32 of the electrically driven vehicle 12 or the large power accumulation battery 56, which is connected via the power cable.

A control unit 62 includes, for example, a CPU or a microcomputer. The control unit 62 controls each unit of the charging and discharging apparatus 14. Further, as illustrated in FIG. 3, the control unit 62 can also function as a display control unit 64, a management content determination unit 66, and a charging and discharging processing unit 68. Processing of the display control unit 64, the management content determination unit 66, and the charging and discharging processing unit 68 to be described below is executed in a state where the electrically driven vehicle 12 and the charging and discharging apparatus 14 are connected to each other via the power cable.

The display control unit 64 controls a display of the display unit 52. In particular, the display control unit 64 causes the display unit 52 to display the current trading price 82 of power acquired by the communication unit 50 from the power company 18 (or the wholesale power trading center) via the communication line 22. In the present embodiment, the display control unit 64 causes the display unit 52 to display a trading price display screen including the current trading price 82 of power. The display control unit 64 may cause the display unit 52 to display the trading price display screen in response to the user's instruction, or cause the display unit 52 to display the trading price display screen in response to a connection of the electrically driven vehicle 12 to the charging and discharging apparatus 14 via the power cable, or detection of the electrically driven vehicle 12 by the charging and discharging apparatus 14 via near-field communication.

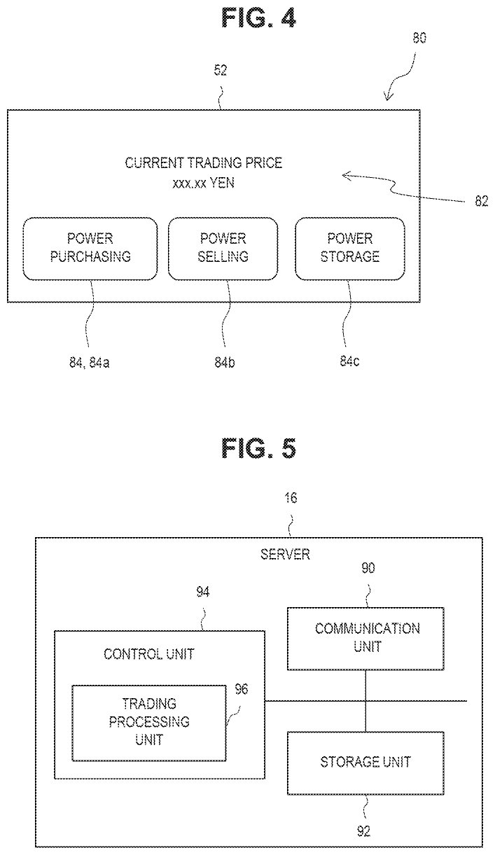

FIG. 4 illustrates an example of a trading price display screen 80. As described above, a current trading price 82 of the power acquired from the power company 18 is displayed on the trading price display screen 80. Since the current trading price 82 changes over time, the display control unit 64 changes the displayed current trading price 82 every moment while the trading price display screen 80 is being displayed. The user can easily recognize the current trading price 82 by checking the trading price display screen 80.

Returning to FIG. 3, in response to the user's instruction input from the input unit 54, the management content determination unit 66 determines management content for trading the power of the battery 32 of the electrically driven vehicle 12. In the present specification, “trading” refers to exchanges of power and money between the user and the power company 18 (or the wholesale power trading center), that is, power purchasing and power selling, and “management” refers to a concept that includes not only power purchasing and power selling but also a method of using power, such as power storage (details thereof will be described below). Further, the management content determined by the management content determination unit 66 is a concept that includes a management type and a power management amount.

First, in response to the user's instruction, the management content determination unit 66 selects a selection management type from among a plurality of management types prepared in advance. In the present embodiment, the management types prepared in advance are power purchasing in which the user purchases power from the power company 18 to charge the battery 32, power selling in which the user sells the power from the discharged battery 32 to the power company 18, and power storage in which the user stores, as power of the user, the power discharged from the battery 32 in the large power accumulation battery 56 of the charging and discharging apparatus 14. The management types that can be selected by the user are not limited to the above, and may include, for example, power lending in which the user lends power to another user and power borrowing in which the user borrows power from another user.

In the present embodiment, as illustrated in FIG. 4, management type selection buttons 84 that enable the user to select a management type are displayed on the trading price display screen 80. A liquid crystal panel serving as the display unit 52 is a touch panel (that is, the liquid crystal panel serves as the display unit 52 and the input unit 54), and the user can select a selection management type by operating the management type selection button 84. Specifically, when the user touches a power purchasing button 84a, the management content determination unit 66 selects power purchasing as the selection management type, and when the user touches a power selling button 84b, the management content determination unit 66 selects power selling as the selection management type. When the user touches a power storage button 84c, the management content determination unit 66 selects power storage as the selection management type.

The user may input the selection management type using another method. For example, as the input unit 54, a mechanical power purchasing button, power selling button, and power storage button may be provided, and the management content determination unit 66 may select the selection management type according to an operation of a mechanical button.

Next, after selecting the selection management type, the management content determination unit 66 determines the power management amount in response to the user's instruction. In the present embodiment, when the user operates the management type selection button 84 on the trading price display screen 80, the display control unit 64 causes the display unit 52 to display the power management amount input screen (not shown) that enables the user to input the power management amount. The user inputs the power management amount on the power management amount input screen. Specifically, when the user has selected the power purchasing button 84a, the user inputs a power purchasing amount on the power management amount input screen, and when the user has selected the power selling button 84b, the user inputs a power selling amount on the power management amount input screen. When the user has selected the power storage button 84c, the user inputs a power storage amount on the power management amount input screen. Based on the input, the management content determination unit 66 determines the power management amount.

The charging and discharging processing unit 68 executes charging and discharging processing of the battery 32 according to the management content determined by the management content determination unit 66. Specifically, when the management content determination unit 66 has selected power purchasing as the selection management type, the charging and discharging processing unit 68 charges the battery 32 with power corresponding to the determined power purchasing amount (that is, the amount purchased by the user) from the power grid through the power transmission/reception unit 60. Further, when the management content determination unit 66 has selected power selling as the selection management type, the charging and discharging processing unit 68 discharges the battery 32 by power corresponding to the determined power selling amount (that is, the amount sold by the user) and transmits the power to the power grid through the power transmission/reception unit 60. Further, when the management content determination unit 66 has selected power storage as the selection management type, the charging and discharging processing unit 68 discharges the battery 32 by an amount of power corresponding to the determined power storage amount and charges the large power accumulation battery 56 with power.

When the management content determination unit 66 has selected power purchasing or power selling as the selection management type and in response to the selection, the charging and discharging apparatus 14 has charged/discharged the battery 32, the control unit 62 of the charging and discharging apparatus 14 sends, to the server 16, power trading information indicating the user ID that indicates the user, the management content (the management type and the power management amount), and the current trading price 82 of power. Further, when the management content determination unit 66 has selected power storage as the selection management type and in response to the selection, the charging and discharging apparatus 14 has charged the large power accumulation battery 56 with power (stored power in the large power accumulation battery 56) from the discharged battery 32, the control unit 62 stores the user ID indicating the user in association with the stored power amount in the storage unit (not shown) of the charging and discharging apparatus 14.

The user can use the power stored in the large power accumulation battery 56 at any time. For example, at a time when the power trading price rises, the user can sell the power stored in the large power accumulation battery 56 in advance. When the power stored in the large power accumulation battery 56 is sold, the control unit 62 also sends, to the server 16, the user ID indicating the user and the information indicating the management content. As such, since the power stored in the large power accumulation battery 56 can also be a target to be traded later, it can be said that the power storage as the management type is also included in management of trading the power of the battery 32. Further, when an amount of the remaining power of the battery 32 of the electrically driven vehicle 12 is reduced, the battery 32 can be charged with the power stored in the large power accumulation battery 56 without purchasing new power.

In the present embodiment, power is purchased from and sold to the power grid (the power company 18), but when there is the above-described wholesale power trading center, the user can purchase and sell power from and to the wholesale power trading center. In this case, when the user has selected power purchasing, the charging and discharging processing unit 68 may charge the battery 32 with the power from the wholesale power trading center, and when the user has selected power selling, the charging and discharging processing unit 68 may transmit the power from the battery 32 to the wholesale power trading center.

FIG. 5 is a schematic diagram of a configuration of the server 16. The server 16 is composed of a computer and executes deposit/withdrawal processing for the user who has purchased or sold power.

A communication unit 90 is composed of, for example, a network adapter. The communication unit 90 exhibits a function of communicating with other devices, such as the charging and discharging apparatus 14 via the communication line 22.

A storage unit 92 is composed of, for example, a hard disk, a ROM, or a RAM. The storage unit 92 stores the user ID of the user registered in the power trading system 10 in advance and information indicating a deposit/withdrawal destination of the user (for example, an account number) in association with each other.

A control unit 94 is composed of, for example, a CPU. As illustrated in FIG. 5, the control unit 94 functions as a trading processing unit 96.

The trading processing unit 96 executes deposit/withdrawal processing for the user based on the power trading information received from the charging and discharging apparatus 14. Specifically, upon receiving, from the charging and discharging apparatus 14, the power trading information in which the management content is power purchasing, the trading processing unit 96 executes the withdrawal processing for withdrawing money, which is calculated based on the power management amount (the power purchasing amount) and a power trading price that are included in the power trading information, from the user indicated by the user ID included in the power trading information. The withdrawn money is transferred to the power company 18. Further, upon receiving, from the charging and discharging apparatus 14, the power trading information in which the management content is power selling, the trading processing unit 96 executes the deposit processing for depositing money, which is calculated based on the power management amount (the power selling amount) and a power trading price that are included in the power trading information, to the user indicated by the user ID included in the power trading information. The money to be deposited is paid by the power company 18.

The overview of the power trading system 10 according to the present embodiment has been described as above. With the power trading system 10, when the user manages the power of the battery 32 of the electrically driven vehicle 12, the current trading price 82 of the power is displayed on the display unit 52 of the charging and discharging apparatus 14. Therefore, the user can appropriately determine the management content for the power as an asset, based on the current trading price 82 of the power.

For example, when the power trading price is low, it is possible to actively select power purchasing while refraining from selecting power selling. On the other hand, when the power trading price is high, it is possible to actively select power selling while refraining from selecting power purchasing. Further, even though the charging amount of the battery 32 is close to the permissible charging amount (close to the full charging amount), when the current trading price 82 is low, by selecting power storage, it is possible to move at least a part of the power of the battery 32 to the large power accumulation battery 56. As such, the battery 32 can be further charged with power generated by the power generation unit 36. In other words, the power amount as an asset can be further increased. Thereafter, at a time when the power trading price rises, the user can also sell the power stored in the large power accumulation battery 56 and the power with which the battery 32 is newly charged. In this manner, the user can profit from power trading.

Further, a selling price threshold value, which is a threshold value for the power trading price, may be set in advance. The set selling price threshold value is stored in the charging and discharging apparatus 14 in advance. In the present embodiment, the selling price threshold value is set by the user. Alternatively, the selling price threshold value may be automatically set by the control unit 62 of the charging and discharging apparatus 14. Specifically, the control unit 62 may predict future changes in the trading price based on the past trading history of the user and the past changes in the power trading price, and then set the selling price threshold value so as to maximize an expected value of profit to be generated by the user's power trading.

After the selling price threshold value is set, when the current trading price 82 of power is lower than the selling price threshold value, the management content determination unit 66 does not have to select power selling as the management type, that is, does not have to allow the user to sell power (prohibit power selling). Specifically, when the current trading price 82 of power is lower than the selling price threshold value, even though the user operates the power selling button 84b on the trading price display screen 80 (see FIG. 4), the management content determination unit 66 invalidates the operation. Alternatively, the display control unit 64 does not have to cause the display unit 52 to display the power selling button 84b on the trading price display screen 80.

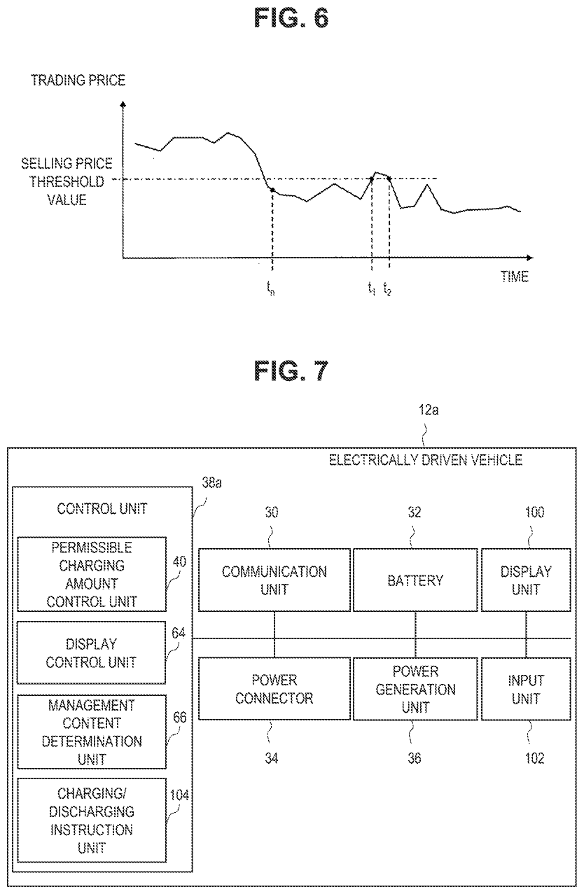

FIG. 6 is a graph illustrating changes in the power trading price over time and the selling price threshold value. In the graph of FIG. 6, a horizontal axis represents time and a vertical axis represents the power trading price. A dash-dot-dash line represents a selling price threshold value set in advance. At current time tₙ, the power trading price is lower than the selling price threshold value. Therefore, at current time tₙ, the management content determination unit 66 does not allow the user to sell power. When looking at a time after current time tₙ, in a period from time tₙ to time t₁, the power trading price is still lower than the selling price threshold value, and in a period from time t₁ to time t₂, the power trading price is higher than the selling price threshold value. In FIG. 6, in a period after time t₂, the power trading price is again lower than the selling price threshold value. Therefore, the management content determination unit 66 does not allow the user to sell power in the period from time tₙ to time t₁ and in the period after time t₂, and allows the user to sell power in the period from time t₁ to time t₂.

Further, when the user has stored the power from the battery 32 in the large power accumulation battery 56 of the charging and discharging apparatus 14, the user may be able to set the charging and discharging processing unit 68 in advance such that the charging and discharging processing unit 68 automatically sells the power stored in the large power accumulation battery 56 at a time when the power trading price reaches the selling price threshold value. At current time tₙ illustrated in FIG. 6, when the user has stored the power from the battery 32 in the large power accumulation battery 56 and has set the charging and discharging processing unit 68 as above, the charging and discharging processing unit 68 automatically transmits (that is, sells) the user's power stored in the large power accumulation battery 56 to the power grid at time t₁ when the power trading price reaches the selling price threshold value. As such, the user can automatically sell the power at a time when the power trading price reaches the selling price threshold value. At this time, the user may also be able to set the power selling amount in advance.

In the present embodiment, the current trading price 82 of power is displayed on the display unit 52 of the charging and discharging apparatus 14 and the user inputs, to the charging and discharging apparatus 14, the management content of the power for the battery 32. However, the display of the current trading price 82 of power and the input of the management content may be executed in the electrically driven vehicle 12.

FIG. 7 is a schematic diagram of a configuration of an electrically driven vehicle 12a according to a modified embodiment. Configuration components that exhibit the same functions as those of the electrically driven vehicle 12 in the above-described embodiment are given the same reference signs as those in FIG. 2 and the description thereof will be omitted.

The electrically driven vehicle 12a further includes a display unit 100 composed of a liquid crystal panel or the like, and an input unit 102 composed of a touch panel, a button, or the like. A control unit 38a of the electrically driven vehicle 12a has the functions of the display control unit 64 and the management content determination unit 66 that the control unit 62 of the charging and discharging apparatus 14 has in the above embodiment.

The display control unit 64 of the electrically driven vehicle 12a receives the current trading price 82 of power from the charging and discharging apparatus 14 via near-field communication and causes the display unit 100 to display the price. Alternatively, the display control unit 64 of the electrically driven vehicle 12a may directly receive the current trading price 82 of power by communicating with the power company 18 or the wholesale power trading center, and cause the display unit 100 to display the price. The display control unit 64 of the electrically driven vehicle 12a may cause the display unit 100 to display the trading price display screen 80 illustrated in FIG. 4.

The management content determination unit 66 of the electrically driven vehicle 12a determines the management content for trading the power of the battery 32 according to the user's instruction input from the input unit 102.

By sending the management content determined by the management content determination unit 66 to the charging and discharging apparatus 14, a charging and discharging instruction unit 104 causes the charging and discharging apparatus 14 to execute the charging and discharging processing on the battery 32 according to the management content. When the user has selected power purchasing or power selling as the management content and the charging and discharging apparatus 14 has charged/discharged the battery 32 in response to the instruction of the charging and discharging instruction unit 104, the charging and discharging instruction unit 104 sends the power trading information to the server 16. Further, when the user has selected power storage as the management content and in response to the selection, the charging and discharging apparatus 14 charges the large power accumulation battery 56 with power (stored power in the large power accumulation battery 56) from the discharged battery 32, the charging and discharging instruction unit 104 sends the user ID indicating the user and information indicating the power storage amount to the charging and discharging apparatus 14 and stores the above user ID and information in the storage unit (not shown) of the charging and discharging apparatus 14.

Further, the display of the current trading price 82 of power and the input of the management content may be executed on the user terminal 20.

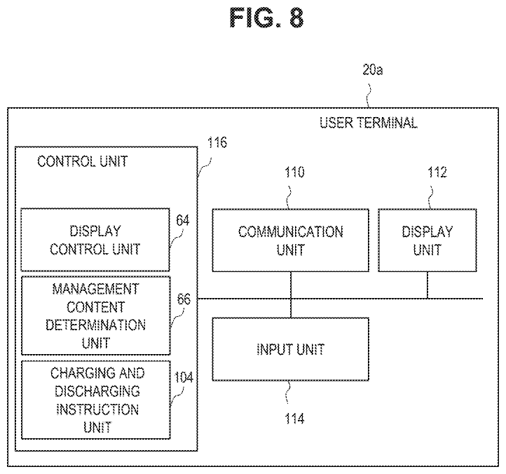

FIG. 8 is a schematic diagram of a configuration of a user terminal 20a according to the modified embodiment.

A communication unit 110 is composed of a network adapter, a near-field network adapter, or the like, and exhibits a function of communicating with the server 16 and the power company 18 via the communication line 22. Further, the communication unit 110 exhibits a function of communicating with the charging and discharging apparatus 14 via near-field communication. A display unit 112 is composed of a liquid crystal panel or the like, and an input unit 114 is composed of a touch panel, a button, or the like.

A control unit 116 is composed of, for example, a CPU or a micro-controller. The control unit 116 has the functions of the display control unit 64, the management content determination unit 66, and the charging and discharging instruction unit 104 that the electrically driven vehicle 12a has in the above-described modified embodiment.

The display control unit 64 of the user terminal 20a causes the display unit 112 to display the current trading price 82 of power received from the charging and discharging apparatus 14, the power company 18, or the wholesale power trading center. The display control unit 64 may cause the display unit 112 to display the trading price display screen 80 illustrated in FIG. 4.

The management content determination unit 66 of the user terminal 20a determines the management content for trading the power of the battery 32 according to the user's instruction input from the input unit 114.

Since processing of the charging and discharging instruction unit 104 of the user terminal 20a is the same as the processing of the charging and discharging instruction unit 104 of the electrically driven vehicle 12a, the description thereof will be omitted.

Further, the display control unit 64 and the management content determination unit 66 do not necessarily have to be included in the same apparatus. For example, the display control unit 64 may be provided in the charging and discharging apparatus 14, and the management content determination unit 66 may be provided in the user terminal 20. In this case, the current trading price 82 of power is displayed on the display unit 52 of the charging and discharging apparatus 14, and the user checks the price and inputs the management content for trading the power of the battery 32 to the user terminal 20.

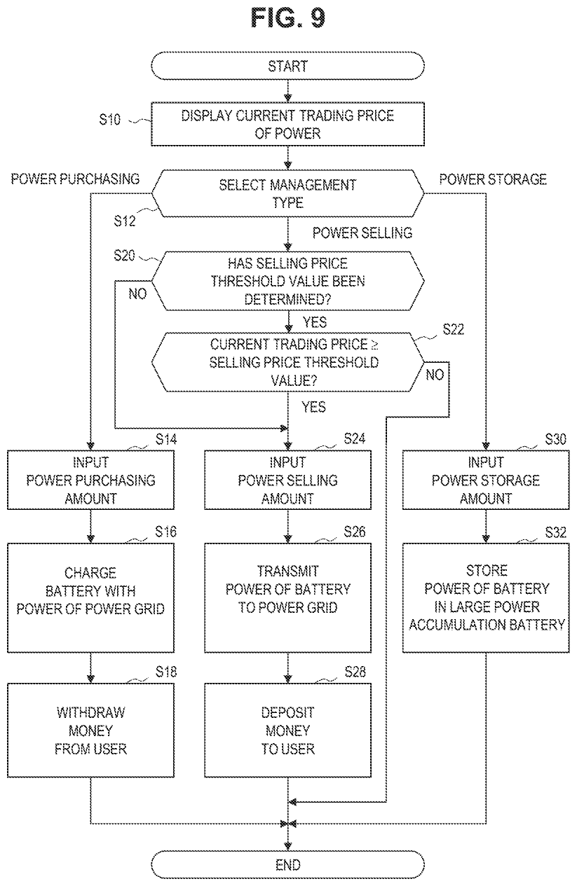

Hereinbelow, a flow of processing of the power trading system 10 will be described with reference to a flowchart illustrated in FIG. 9. At the start of the flowchart of FIG. 9, it is assumed that the electrically driven vehicle 12 and the charging and discharging apparatus 14 are connected via the power cable.

In step S10, the display control unit 64 of the charging and discharging apparatus 14 causes the display unit 52 to display the trading price display screen 80 including the current trading price 82 of the power acquired from the power company 18.

In step S12, the user operates one of the management type selection buttons 84 included in the trading price display screen 80 with reference to the current trading price 82 that is displayed in step S10. The management content determination unit 66 selects the management type for trading the power of the battery 32 of the electrically driven vehicle 12 according to the management type selection button 84 operated by the user.

When the management content determination unit 66 has selected power purchasing in step S12, the process proceeds to step S14.

In step S14, the user inputs the power purchasing amount by the input unit 54 of the charging and discharging apparatus 14. The management content determination unit 66 determines the power purchasing amount according to the input of the user.

In step S16, the charging and discharging processing unit 68 charges the battery 32 of the electrically driven vehicle 12 with the power of the power grid according to the management content determined in steps S12 and S14. Thereafter, the control unit 62 of the charging and discharging apparatus 14 sends, to the server 16, the power trading information indicating the user ID which indicates the user, the management content (the management type and the power management amount), and the current trading price 82 of power.

In step S18, the trading processing unit 96 of the server 16 withdraws money from the user based on the power trading information received in step S16.

When the management content determination unit 66 has selected power selling in step S12, the process proceeds to step S20.

In step S20, the management content determination unit 66 determines whether the user has set the selling price threshold value. When the selling price threshold value has been set, the process proceeds to step S22. On the other hand, when the selling price threshold value has not been set, the process skips step S22 and proceeds to step S24.

In step S22, the management content determination unit 66 determines whether the current trading price 82 of power is equal to or higher than the selling price threshold value. When the current trading price 82 of power is lower than the selling price threshold value, the process ends here. The process may stop proceeding until the power trading price reaches the selling price threshold value. When the current trading price 82 of power is equal to or higher than the selling price threshold value, the process proceeds to step S24.

In step S24, the user inputs the power selling amount by the input unit 54 of the charging and discharging apparatus 14. The management content determination unit 66 determines the power selling amount according to the user's input.

In step S26, the charging and discharging processing unit 68 transmits the power of the battery 32 to the power grid according to the management content determined in steps S12 and S24. Thereafter, the control unit 62 of the charging and discharging apparatus 14 sends the power trading information to the server 16.

In step S28, the trading processing unit 96 of the server 16 deposits money to the user based on the power trading information received in step S26.

When the management content determination unit 66 has selected power storage in step S12, the process proceeds to step S30.

In step S30, the user inputs the power storage amount by the input unit 54 of the charging and discharging apparatus 14. The management content determination unit 66 determines the power storage amount according to the input of the user.

In step S32, the charging and discharging processing unit 68 stores the power of the battery 32 in the large power accumulation battery 56 of the charging and discharging apparatus 14 according to the management content determined in steps S12 and S30. Thereafter, the control unit 62 of the charging and discharging apparatus 14 stores the user ID indicating the user in association with the power storage amount in the storage unit of the charging and discharging apparatus 14.

Although the embodiment of the power trading system for the electrically driven vehicle according to the present disclosure has been described above, the power trading system for the electrically driven vehicle according to the present disclosure is not limited thereto and can be variously modified within a range not departing from the scope of the present disclosure.

What is claimed is:

1. A power trading system for an electrically driven vehicle, the power trading system being configured to trade power for charging and discharging of a battery of the electrically driven vehicle, the power trading system comprising:
a display device configured to display a current trading price of power; and
at least one processor configured to set management content for trading power of the battery in response to an instruction of a user and control the charging and discharging of the battery according to the set management content.

2. The power trading system according to claim 1, wherein the processor is configured to, when the current trading price of power is a price lower than a predetermined threshold value, set, as the management content, management in which power selling for selling the power of the battery is not selected.

3. The power trading system according to claim 1, wherein the processor is configured to control, in response to the instruction of the user, the charging and discharging of the battery while making a permissible charging amount of the battery greater than a normal permissible charging amount.

4. The power trading system according to claim 1, wherein the processor is configured to set the management content based on the management content selected by the user from among a plurality of pieces of management content for trading the power of the battery.

5. The power trading system according to claim 4, wherein the plurality of pieces of management content for trading the power of the battery includes power selling, power purchasing, and power storage.

6. A charging and discharging apparatus configured to control charging and discharging of a battery in a power trading system for an electrically driven vehicle, which trades power for the charging and discharging of the battery of the electrically driven vehicle, the charging and discharging apparatus comprising:
a display device configured to display a current trading price of power; and
at least one processor configured to set management content for trading power of the battery in response to an instruction of a user and control the charging and discharging of the battery according to the set management content.
